(19) United States
(12) Patent Application Publication
(10) Pub. No.: US 2022/0163804 A1
(43) Pub. Date: May 26, 2022

(54) LIGHTGUIDE WITH A FREEFORM INCOUPLER AND A HOLOGRAPHIC OUTCOUPLER

(71) Applicant: GOOGLE LLC, Mountain View, CA (US)

(72) Inventors: Ozan Cakmakci, Sunnyvale, CA (US); Timothy Paul Bodiya, Toronto (CA)

(21) Appl. No.: 17/531,146

(22) Filed: Nov. 19, 2021

Related U.S. Application Data
(60) Provisional application No. 63/116,523, filed on Nov. 20, 2020.

(51) Int. Cl. G02B 27/01; F21V 8/00; G02B 27/00; G03H 1/02

(52) U.S. Cl. CPC G02B 27/0172; G02B 6/0035; G02B 27/0081; G02B 2027/0178; G02B 27/0025; G02B 2027/0174; G03H 1/0248

(57) ABSTRACT

A lightguide includes an incoupler configured to receive light emitted from a microdisplay and to direct the received light into the lightguide, a first non-planar major surface and a second non-planar major surface configured to reflect the light directed into the lightguide by the incoupler, and an outcoupler comprising a non-planar, angle selective hologram configured to receive light reflected from at least one of the first major surface and the second major surface and to selectively direct the light out of the lightguide based on the angle of incidence at the hologram.

### BACKGROUND

Wearable electronic eyewear devices include optical systems that magnify a display image and deliver a virtual image into the field of view (FOV) of a user. In some cases, wearable electronic eyewear devices also allow the user to see the outside world through a lens or see-through eyepiece. Some wearable electronic eyewear devices incorporate a near-to-eye optical system to display content to the user. These devices are sometimes referred to as head-mounted displays (HMDs). For example, conventional HMD designs include a microdisplay (“display”) positioned in a temple or rim region of a head wearable frame like a conventional pair of eyeglasses. The display generates images, such as computer-generated images (CGI), that are conveyed into the FOV of the user by optical elements such as curved lightguides deployed in the lens (or “optical combiner”) of the head wearable display frame. The wearable electronic eyewear device can therefore serve as a hardware platform for implementing augmented reality (AR) or mixed reality (MR). Different modes of augmented reality include optical see-through augmented reality, video see-through augmented reality, or opaque (VR) modes.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example head-mounted display (HMD) employing an optical combiner through which images projected by the HMD are displayed, in accordance with some embodiments.

FIG. 2 illustrates a block diagram of a projection system that projects images directly onto the eye of a user via a curved lightguide of an HMD, such as the HMD of FIG. 1, in accordance with some embodiments.

FIG. 3 illustrates a block diagram of a projection system having a curved outcoupler to project images from a curved lightguide of an HMD, such as the HMD of FIG. 1, in accordance with some embodiments.

### DETAILED DESCRIPTION

Head-mounted displays (HMDs) potentially have multiple practical and leisure applications, but the development and adoption of wearable electronic display devices have been limited by constraints imposed by the quality, cost, size, weight, thickness, field of view (FOV), and efficiency of the optical systems used to implement existing display devices. For example, the geometry and physical constraints of conventional designs result in displays having relatively small FOVs. Furthermore, the population of potential users exhibits a large range of facial geometries characterized by a distribution of nose geometries, a distribution of distances from ear apex to ear apex, and a distribution of interpupillary distances (i.e., a distance between centers of the user's pupils). A single wearable electronic display device design is not likely to provide an optimal experience for all users while meeting all the physical and geometric constraints of a wearable device. For example, a user only sees the entirety of the image displayed by the wearable electronic eyewear device if the user's pupils fall within an “eyebox” produced by the optical system implemented in the device. However, a conventional HMD produces a relatively small eyebox that does not encompass pupil locations throughout the entire distribution of facial geometries. Consequently, not all users are able to view the image displayed by the HMD.

As used herein, the term “eyebox” refers to a three-dimensional (3D) volume in space within which the pupil of an eye is positioned in order to satisfy one or more viewing experience criteria. One example of a viewing experience criterion is that the user sees four edges of a magnified virtual image. In that case, the eyebox is the 3D volume in space within which the user's pupil is positioned to see the four edges of the magnified virtual image. In some embodiments, the volume of the eyebox produced by an electronic eyewear device is evaluated based on pupil diameter, an angular extent of an emission cone produced by the electronic eyewear device, a set of criteria, and thresholds for the criteria. Thus, increasing the pupil diameter increases the eyebox of an HMD, meaning the HMD can be used by a larger population of potential users with differing facial sizes and geometries.

The optical performance of an HMD is an important factor in its design; however, users also care significantly about aesthetics of wearable devices. Independent of their performance limitations, many of the conventional examples of wearable heads-up displays have struggled to find traction in consumer markets because, at least in part, they lack fashion appeal. Some wearable HMDs employ planar lightguides in planar transparent combiners and, as a result, appear very bulky and unnatural on a user's face compared to the sleeker and more streamlined look of typical curved eyeglass and sunglass lenses. Thus, it is desirable to integrate curved lenses with lightguides in wearable heads-up displays or eyewear in order to achieve the form factor and fashion appeal expected of the eyeglass and sunglass frame industry.

Another consideration in HMD design is that uniform distribution of the light intensity decreases as the FOV increases, thus decreasing the quality of the image(s) or content displayed to a user. This is, in part, because light of different wavelengths travels at different angles in the lightguide, especially where the lightguide includes diffractive incouplers. This translates to different travel distances between each instance of total internal reflection (TIR) of the light within the lightguide, resulting in a different number of times that each wavelength of light interacts with an outcoupler of a conventional lightguide. For example, light having a relatively small wavelength (e.g., blue light) will experience more instances of TIR within a lightguide than light of a larger wavelength (e.g., red light) and, thus, is likely to interact with the outcoupler more times. Consequently, a greater amount of light of the smaller wavelengths is outcoupled from the lightguide than light of the larger wavelengths, creating an uneven distribution of color and intensity in the image(s) displayed to the user via the HMD.

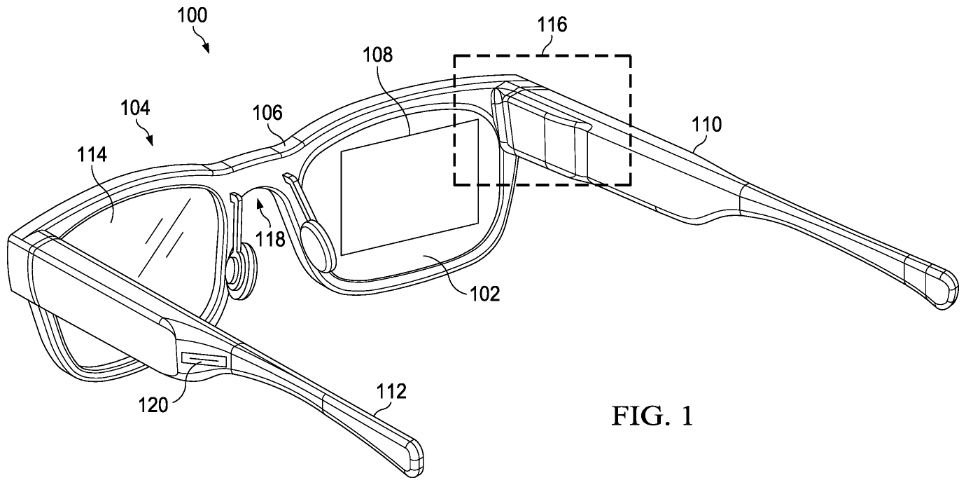

FIGS. 1-3 illustrate thin, curved lightguides that employ at least one holographic outcoupler to achieve a relatively large pupil diameter (i.e., eyebox), as well as efficient and uniform outcoupling of light. The lightguides can be implemented in a variety of HMDs, including those with an eyeglass form factor. In general, the terms “incoupler” and “outcoupler” refer to certain types of optical structures, including, but not limited to, transmissive gratings (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection.

FIG. 1 illustrates an example HMD 100 employing an optical combiner 102 through which images projected by the HMD are displayed. The HMD 100 has a support structure 104 that includes a frame 106, which houses a microdisplay, such as a laser microdisplay or light-emitting diode (LED) display, that generates visible light in order to project images toward the eye of a user via the optical combiner 102, such that the user perceives the projected images as being displayed in a field of view (FOV) area 108 through the combiner 102.

Support structure 104 also includes components to allow the support structure 104 to be worn in a position in front of a user's eyes. Examples of such components are arms 110 and 112 to be supported by a user's ears. A strap, or straps (not shown), configured to be worn around and/or on top of a user's head may be used in place of one or more of the arms in some embodiments to secure the support structure 104 in front of a user's eyes. In some embodiments, the HMD 100 is symmetrically configured as a binocular display such that lens element 114 is also a combiner and a microdisplay is housed in the portion of the frame 106 proximate to arm 112 to project images to a FOV area within lens element 114. Frame 106 also includes a nose bridge 118 disposed between combiner 102 and lens elements 114.

In the depicted example, the HMD 100 is a near-eye display system in which the support structure 104 is configured to be worn on the head of a user and has a general shape and appearance (or “form factor”) of an eyeglasses frame. The support structure 104 contains or otherwise includes various components to facilitate the projection of images toward the eye of the user, such as a processing system (not shown). In some embodiments, the support structure 104 further includes various sensors, such as one or more front-facing cameras, rear-facing cameras, other light sensors, motion sensors, accelerometers, and the like. The support structure 104 further can include one or more connection interfaces, as well as radio frequency (RF) interfaces or other wireless interfaces, such as a Bluetooth™ interface, a WiFi interface, and the like. Further, in some embodiments, the support structure 104 includes one or more batteries or other portable power sources for supplying power to the electrical and processing components, such as one or more processors of a processing system of the HMD 100. In some embodiments, some or all of these components of the HMD 100 are fully or partially contained within an inner volume of support structure 104, such as within arm 110 and the portion of the frame 106 in region 116 of the support structure 104. It should be noted that while an example form factor is depicted, in other embodiments the HMD 100 may have a different shape and appearance from the eyeglasses frame depicted in FIG. 1.

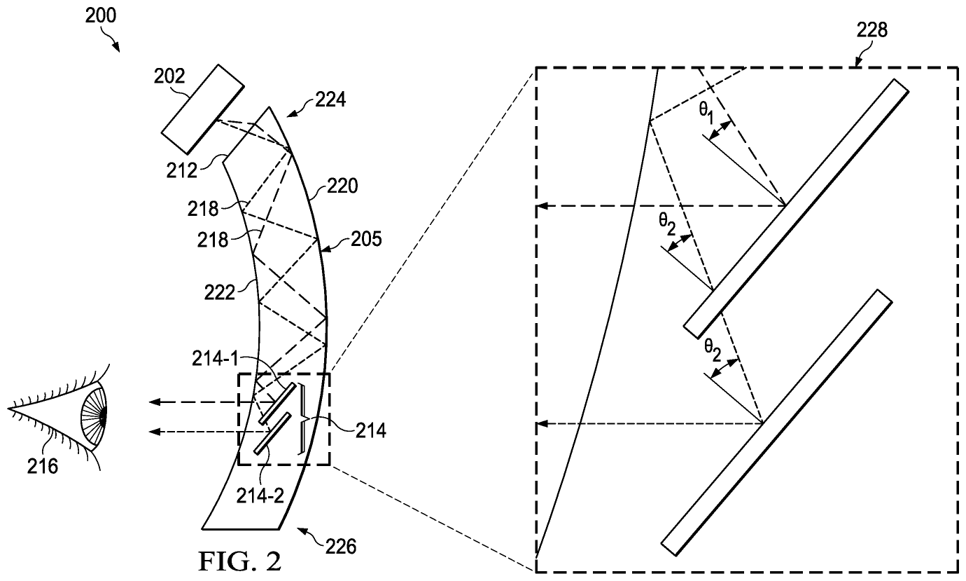

In the depicted embodiment, combiner 102 of the HMD 100 provides an AR display in which rendered graphical content can be superimposed over or otherwise provided in conjunction with a real-world view as viewed by the user through combiner 102. For example, light used to form a perceptible image or series of images may be projected by a microdisplay of the HMD 100 to an eyebox via a series of optical elements, such as a lightguide formed at least partially in combiner 102, and one or more lenses and/or filters disposed between the microdisplay and the lightguide. Optical combiner 102 includes at least a portion of a lightguide that routes display light received by an incoupler of the lightguide to an eye of a user of the HMD 100, as described in greater detail below with reference to FIG. 2. In addition, optical combiner 102 is sufficiently transparent to allow a user to see through combiner 102 to provide a field of view of the user's real-world environment such that the image appears superimposed over at least a portion of the user's real-world environment.

FIG. 2 illustrates a block diagram of a projection system 200 that projects images directly onto the eye of a user via a curved lightguide 205. The projection system 200 includes a microdisplay 202 and the curved lightguide 205 includes an incoupler 212 and an outcoupler 214. The outcoupler 214 is optically aligned with an eye 216 of a user in the present example. In some embodiments, the projection system 200 is implemented in a wearable heads-up display or other display system, such as the HMD system 100 of FIG. 1.

The microdisplay 202 includes one or more light sources configured to generate and output light 218 (e.g., visible light such as red, blue, and green light and, in some embodiments, non-visible light such as infrared light). In some embodiments, the microdisplay 202 is coupled to a driver or other controller (not shown), which controls the timing of emission of light from the light sources of the microdisplay 202 in accordance with instructions received by the controller or driver from a computer processor coupled thereto to modulate the light 218 to be perceived as images when output to the retina of an eye 216 of the user.

The term “lightguide,” as used herein, refers to a combiner using one or more of total internal reflection (TIR), specialized filters, or reflective surfaces, to transfer light from an incoupler (such as the incoupler 212) to an outcoupler (such as the outcoupler 214). In some display applications, light 218 is a collimated image (i.e., parallel beams of light that form an image), and the lightguide 205 transfers and replicates the collimated image to the eye. In the present example, the light 218 received at the incoupler 212 is relayed to the outcoupler 214 via the lightguide 205 using TIR. The light 218 is then output to the eye 216 of a user via the outcoupler 214. Lightguide 205 further includes two major surfaces 220 and 222 of the substrate from which the lightguide is formed, with major surface 220 being world-facing (i.e., the surface farthest from the user) and major surface 222 being eye-facing (i.e., the surface closest to the user). In some embodiments, one or both of the major surfaces 220, 222 is non-planar, for example, each of the major surfaces 220, 222 have one or more radii of curvature about one or more axes. In some embodiments, the distance between the major surfaces 220, 222 is 2 millimeters.

The lightguide 205 also includes a proximal end 224 and a distal end 226 relative to the microdisplay 202. Incoupler 212 is located, at least partially, at the proximal end 224 of lightguide 205. Outcoupler 214 is located at or near the distal end 226 and includes vertically stacked holograms, such as a first hologram 214-1 and a second hologram 214-2. Although not shown in the example of FIG. 2, in some embodiments additional optical components are included in any of the optical paths between the microdisplay 202 and the incoupler 212, between the incoupler 212 and the outcoupler 214, or between the outcoupler 214 and the eye 216 (e.g., in order to shape the light for viewing by the eye 216 of the user). For example, in some embodiments, a prism (not shown) is used to steer light from the microdisplay 202 into the incoupler 212 so that light is coupled into incoupler 212 at the appropriate angle to encourage propagation of the light in lightguide 205 by TIR. Also, in some embodiments, an exit pupil expander, such as a fold grating, is arranged in an intermediate stage between incoupler 212 and outcoupler 214 to receive light that is coupled into lightguide 205 by the incoupler 212, expand the light, and redirect the light towards the outcoupler 214, where the outcoupler 214 then couples the light out of lightguide 205.

During the operation of the projection system 200, light beams are output by the microdisplay 202 and directed into lightguide 205 via the incoupler 212 before being directed to the eye 216 of the user. In some embodiments, the incoupler 212 is a grating disposed at a surface of the lightguide, wherein the grating diffracts different wavelengths of the microdisplay light 218 at different angles. Because of these different diffraction angles, the different wavelengths of the microdisplay light have different angles of propagation within the lightguide and, therefore, their respective angles of incidence on outcoupler 214 will be different as well.

The distance between two adjacent TIR bounces (as measured from the center of the light beam) is known as “bounce separation” and the distance between adjacent bounces of different light beams is referred to as “bounce separation spacing.” As bounce separation and bounce separation spacing between the wavelengths of light increases so does the degradation of color uniformity in the image that is displayed to a user. In other words, because light having a relatively short wavelength (e.g., blue light) has a smaller diffraction angle than light of a longer wavelength (e.g., red light) the blue light will have a smaller bounce separation than the red light. That is, the blue light will experience a greater number of TIR bounces within a given area of a lightguide than the red light and, generally, the blue light will have a smaller bounce separation spacing between light beams than the red light. As a result, when the blue and red light encounter an outcoupler of a lightguide, the blue light will experience a greater number of outcoupling bounces than red light, which results in the blue light exiting the lightguide in more locations than red light. Thus, the image displayed to the viewer will have a relatively consistent saturation of blue color across the image while the saturation of red color will vary in certain areas of the image.

To provide greater consistency in color saturation and intensity, in the present example, the holograms 214-1, 214-2 are three-dimensional (3D) phase gratings in a medium having volume (i.e., a 3D medium), also referred to as volume holograms. The 3D nature of volume holograms 214-1, 214-2 provides high diffraction efficiency (close to 100% at a single wavelength), as well as high angle and spectral selectivity based on the thickness of the holographic material and the interbeam angle used to record the hologram. Thus, each hologram of outcoupler 214 is configured to reflect select beams of light that are incident on the hologram at a specific angle or range of angles while transmitting beams that are incident on the hologram at any angle other than the specific angle or range of angles. For example, hologram 214-1 is configured to reflect light incident thereon at a first angle θ₁ and hologram 214-2 is configured to reflect light incident thereon at a second angle θ₂. Thus, light that is incident on hologram 214-1 at the second angle θ₂ will be transmitted and light that is incident on hologram 214-2 at the first angle θ₁ will be transmitted. Therefore, wavelengths of light that are not outcoupled by the first hologram 214-1 are transmitted through the first hologram 214-1 to the second hologram 214-2, providing a second opportunity for the light to be outcoupled from the HMD, thus increasing pupil diameter and image quality.

While holograms 214-1, 214-2 are shown vertically aligned within lightguide 205 at the same angle relative to major surface 220 (i.e., parallel), it should be appreciated that the angle at which each of holograms 214-1, 214-2 is disposed can be adjusted relative to major surface 220 to change the angle at which light traveling within the lightguide 205 is incident on either of holograms 214-1 or 214-2. That is, the physical properties of holograms 214-1, 214-2 and/or the positioning of holograms 214-1, 214-2 within the lightguide 205 can be adjusted to reflect light of a particular angle of incidence. For example, the optical shape and phase function of each of holograms 214-1, 214-2 can be designed to provide a specific angle and spectral selectivity. While two holograms are illustrated FIG. 2, it should be noted that any number of holograms can be included in outcoupler 214. Providing multiple holograms in outcoupler 214 allows a greater amount of light to be outcoupled from the lightguide 205, thus generating a larger eyebox to enhance a user's experience.

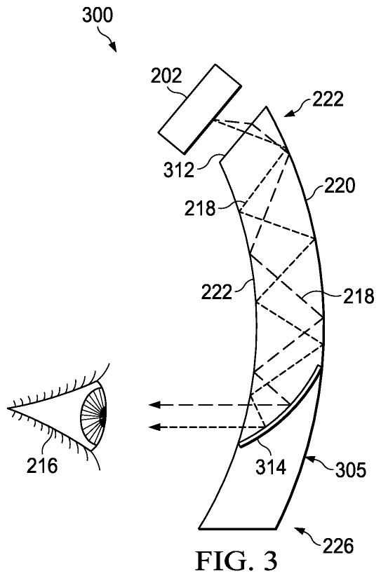

FIG. 3 illustrates a block diagram of another projection system 300 employing a curved holographic outcoupler 314 (i.e., non-planar holographic outcoupler) to project images from a curved lightguide 305 directly onto the eye of a user. The projection system 300 includes a microdisplay, such as microdisplay 202 of FIG. 2, and a curved lightguide 305 having an incoupler 312 and outcoupler 314, with the outcoupler 314 being optically aligned with an eye 216 of a user in the present example. In some embodiments, the projection system 300 is implemented in a wearable heads-up display or other display system, such as the HMD system 100 of FIG. 1.

In some embodiments, microdisplay 202 emits light 218 forming a collimated image, and the lightguide 305 transfers and replicates the collimated image to the eye. In the present example, the light 218 received at the incoupler 312 is relayed to the outcoupler 314 via the lightguide 305 using TIR. The light 218 is then output to the eye 216 of a user via the outcoupler 314. The lightguide 205 further includes two major surfaces 220 and 222, with major surface 220 being world-facing (i.e., the surface farthest from the user) and major surface 222 being eye-facing (i.e., the surface closest to the user). In some embodiments, one or both of the major surfaces 220, 222 is non-planar, for example, each of major surfaces 220, 222 have one or more radii of curvature about one or more axes. In some embodiments, the distance between the major surfaces 220, 222 is approximately 2 millimeters.

In the present example, incoupler 312 is configured as a refractive freeform incoupler. That is, incoupler 312 is formed as a grating surface with no continuous translational or rotational symmetry about axes. Because the curved holographic outcoupler 314 will impart some chromatic aberration and blur to the image as it is projected to the user's eye, the geometry of the freeform incoupler 312 is configured to apply pre-distortion to the image in order to mitigate or compensate for the aberration and blur that will be caused by the curved holographic outcoupler 314. That is, the pre-distortion imparted on the image-forming light by the freeform incoupler 312 as it enters the lightguide 305 is cancelled at the curved holographic outcoupler 314 to project an image free or nearly free of aberrations to the user.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A lightguide comprising:
an incoupler configured to receive light emitted from a microdisplay and to direct the received light into the lightguide;
a first non-planar major surface and a second non-planar major surface configured to reflect the light directed into the lightguide by the incoupler; and
an outcoupler comprising a plurality of volume holograms configured to receive light reflected from at least one of the first non-planar major surface and the second non-planar major surface, wherein the plurality of volume holograms are further configured to direct the light out of the lightguide.

2. The lightguide of claim 1, wherein a first volume hologram of the plurality of volume holograms is configured to have angle selectivity for light incident on the first volume hologram at a first angle.

3. The lightguide of claim 2, wherein a second volume hologram of the plurality of volume holograms is configured to have angle selectivity for light incident on the second volume hologram at a second angle, the second angle being different from the first angle.

4. The lightguide of claim 3, wherein the first volume hologram is configured to transmit light incident on the first volume hologram at an angle other than the first angle.

5. The lightguide of claim 3, wherein the second volume hologram is configured to transmit light incident on the second volume hologram at an angle other than the second angle.

6. The lightguide of claim 1, wherein the plurality of volume holograms is vertically stacked within the lightguide.

7. The lightguide of claim 6, wherein the plurality of volume holograms is aligned to be parallel within the lightguide.

8. The lightguide of claim 6, wherein each of the plurality of volume holograms is disposed within the lightguide at an angle relative to the first non-planar major surface that is unique from the angles at which the other of the plurality of volume holograms are disposed.

9. The lightguide of claim 1, wherein the distance between the first non-planar major surface and the second non-planar major surface is approximately 2 mm.

10. A lightguide comprising:
an incoupler configured to receive light emitted from a microdisplay and to direct the received light into the lightguide;
a first non-planar major surface and a second non-planar major surface configured to reflect the light directed into the lightguide by the incoupler; and
an outcoupler comprising a non-planar hologram configured to receive light reflected from at least one of the first major surface and the second major surface, wherein the non-planar hologram is further configured to direct the light out of the lightguide.

11. The lightguide of claim 10, wherein the incoupler is a refractive freeform incoupler.

12. The lightguide of claim 11, wherein the refractive freeform incoupler is configured to apply pre-distortion to the light to compensate for optical aberration imparted on the light by the non-planar hologram.

13. The lightguide of claim 10, wherein the distance between the first non-planar major surface and the second non-planar major surface is approximately 2 mm.

14. A head-mounted display comprising:
a microdisplay housed within a support structure of the head-mounted display;
a lightguide supported by the support structure and optically coupled to the microdisplay, the lightguide comprising:
an incoupler configured to receive light emitted from the microdisplay and to direct the received light into the lightguide;
a first non-planar major surface and a second non-planar major surface configured to reflect the light directed into the lightguide by the incoupler; and
an outcoupler comprising a plurality of volume holograms configured to receive light reflected from at least one of the first major surface and the second major surface, wherein the plurality of volume holograms are further configured to direct the light out of the lightguide.

15. The head-mounted display of claim 14, wherein a first volume hologram of the plurality of volume holograms is configured to have angle selectivity for light incident on the first volume hologram at a first angle.

16. The head-mounted display of claim 15, wherein a second volume hologram of the plurality of volume holograms is configured to have angle selectivity for light incident on the second volume hologram at a second angle, the second angle being different from the first angle.

17. The head-mounted display of claim 16, wherein the first volume hologram is configured to transmit light that is incident on the first volume hologram at an angle other than the first angle.

18. The head-mounted display of claim 16, wherein the second volume hologram is configured to transmit light that is incident on the second volume hologram at an angle other than the second angle.

19. The head-mounted display of claim 14, wherein the plurality of volume holograms are vertically stacked within the lightguide and aligned to be parallel.

20. The head-mounted display of claim 14, wherein the plurality of volume holograms are vertically stacked within the lightguide and wherein each of the plurality of volume holograms is disposed within the lightguide at an angle relative to the first non-planar surface that is unique from the angles at which the other of the plurality of volume holograms are disposed.
